(19) United States
(12) Patent Application Publication
(10) Pub. No.: US 2024/0013759 A1
(43) Pub. Date: Jan. 11, 2024

(54) GUITAR WITH AN EFFECTOR IN AN INTEGRAL FORM

(71) Applicant: Rae-Sun PARK, Icheon-si (KR)

(72) Inventor: Rae-Sun PARK, Icheon-si (KR)

(21) Appl. No.: 18/039,944

(22) PCT Filed: Dec. 4, 2020
(86) PCT No.: PCT/KR2020/017670

§ 371 Date: Jun. 1, 2023

(51) Int. Cl. G10H 1/053; G10D 1/08; G10H 3/18

(52) U.S. Cl. CPC G10H 1/053; G10D 1/085; G10H 3/186

(57) ABSTRACT

Provided is a guitar with an effector in an integral form. The guitar comprises a body forming a portion of the guitar 11; and an effector 12 installed within the body, wherein the effector 12 is connected to the guitar 12 electrically in advance, and the effector starts an operation when the guitar 11 is connected to an amplifier 13 electrically.

### BACKGROUND OF THE INVENTION

### 1. Field of the Invention

The present invention relates to a guitar with an effector in an integral form, in particular a guitar having the effector embedded within the guitar body in an integral form.

### 2. Description of the Related Art

An electric guitar converts a vibration of a metal string into an electric vibrating signal for generating a sound, and the sound may be emitted through an amplifier. An effector may be installed at a transmission path of the electric signal of the electric guitar for generating various sound effects. For example, an over-drive, a distortion, a fuss, a delay, an octave or a tremolo effect may be generated by the effector. A drive type effect or a modulation type effect may be connected for a sound effect generation of the electric guitar between the electric guitar and the amplifier. Korean patent registration no. 10-1377246 discloses an effector using no cable regardless of using various analog type of effector circuits. And also, Korean patent registration no. 10-1514818 discloses an effector for an electric guitar. The effector discussed in the prior art or the known skill may be made in an independent shape, and has to be connected electrically for a performance between the guitar and the amplifier. In this case, the effector has to be connected separately, and at the same time a condition of the effector may has to be set for each performance. Such process may be treated in an ease way to a professional performer or an adept of the electric guitar, but it is difficult for an unskilled person to connect and set the effector. Therefore, an electric guitar for solving such problem may be developed, but the prior art does not disclose such guitar.

The present invention is to solve the problem of the known art, and have a following purpose.

### PURPOSE OF THE INVENTION

An object of the present invention is to provide with a guitar with an effector in an integral form, wherein the effector is installed within the guitar body in a single form.

### SUMMARY OF THE INVENTION

In one embodiment of the present invention, a guitar with an effector in an integral form comprises a body forming a portion of the guitar; and an effector installed within the body; wherein the effector is connected to the guitar electrically in advance, and the effector starts an operation when the guitar is connected to an amplifier electrically.

In other embodiment of the present invention, the effector comprises a regulating board integrated with a body of the guitar; and an operating board integrated with the regulating guitar and located within the body.

In another embodiment of the present invention, the guitar comprises a battery receiving box formed at a rear surface of the body.

The guitar with an effector in an integral form of the present invention comprises an effector installed within the body of the electric guitar in an integral shape, and the effector is connected to the pickup electrically in advance. And thus, the present invention can ensure a portability, a mobility and an installing convenience. The guitar according to the present invention may eliminate a difficulty in using the effector to a beginner of the electric guitar. The effector can be coupled to the guitar in a removable way, and thus various effectors for generating various sound effects may be integrated with the guitar in a replaceable way.

### BRIEF DESCRIPTION OF THE DRAWINGS

FIG. 1 shows an embodiment of a structure of a guitar with an effector in an integral form according to the present invention.

FIG. 2 shows an embodiment of a guitar with an effector in an integral form according to the present invention.

FIG. 3 shows an embodiment of an effector structure coupled to a guitar according to the present invention.

FIG. 4 shows an embodiment of an effector coupled to a guitar according to the present invention.

### DETAILED DESCRIPTION OF EXEMPLARY EMBODIMENTS

Exemplary embodiments of the present invention will be described herein below with reference to the accompanying drawings.

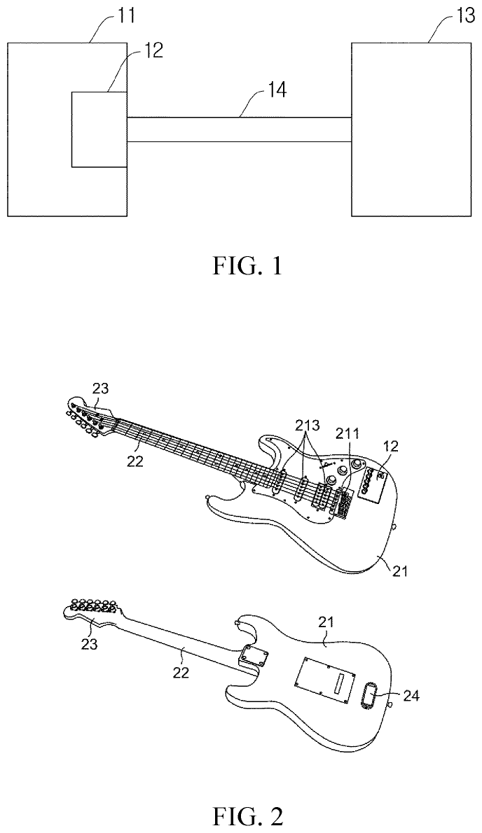

FIG. 1 shows an embodiment of a structure of a guitar with an effector in an integral form according to the present invention.

Referring to FIG. 1, a guitar with an effector in an integral form comprises a body forming a portion of the guitar 11; and an effector 12 installed within the body; wherein the effector 12 is connected to the guitar 12 electrically in advance, and the effector starts an operation when the guitar 11 is connected to an amplifier 13 electrically.

The guitar 11 may comprise various electric guitars, and the present invention is not limited to the kind of a guitar. The electric guitar 11 may comprise a head, a neck and body, for example, and the effector 12 may be installed within the body. The effector 12 may be a drive type of an effector using a clipping circuit or a modulation type of an effector. And also, the effector may generate an overdrive, a distortion, a fuzz, a chorus, a delay, a phase, an octave or a tremolo effect, and at least one effect may be generated by the effector 12. The effector 12 may comprise an electric board having a structure identical with or similar to a printed circuit board or the like; and a regulating board having at least one regulating means for regulating a generation of various effects or a volume of the effects. The regulating board may be coupled to the electric board in a state of an electric connection, and the electric board and the regulating board may have a module structure capable of being secured within the guitar 11 in a combined form. The effector 12 made as the module structure that can be received and secured within the body may be fixed within the body in various ways, and may be connected to the electric guitar 11 electrically. And also, if the electric guitar 11 is connected to an amplifier 12, then the effector 12 may be placed at an electric connecting path. The effect 12 may be integrated with the guitar 12 and be connected electrically or be in a condition to be connected electrically. For example, the effector 12 may connect a pickup and an electrical jack of the guitar electrically, and the electrical jack may be connected to the amplifier 13 by a transmitting line 14. Thus, a vibration of the guitar string can be transmitted to the amplifier 13 via the effector to be emitted to the air with an effect of the effector 12. The effector 12 may comprise various regulating buttons including an on/off switch. A portion of the effector 12 may be placed within the guitar 12 and the other portion of the guitar 12 may be exposed to an outside of the guitar 12. And the effector 12 may be connected to the guitar 11 to receive a vibration generated by a string of the guitar 11, and at the same time, the effector 12 may comprise an electric means for generating an effect of the effector 12. And also, the effector 12 may be connected to a power source for supplying a power to the effector 12. The electric guitar 12 having such structure may be discussed below in more detail.

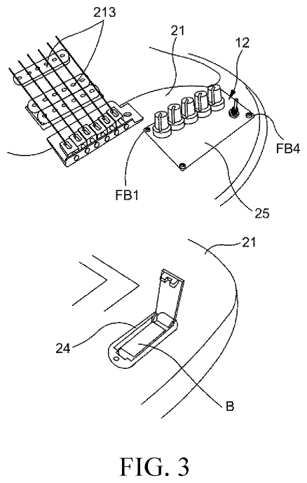

FIG. 2 shows an embodiment of a guitar with an effector in an integral form according to the present invention, and FIG. 3 shows an embodiment of an effector structure coupled to a guitar according to the present invention.

Referring to FIG. 2 and FIG. 3, the effector 12 comprises a regulating board 25 integrated with a body 21 of the guitar 11; and an operating board 26 integrated with the regulating board 25 and located within the body 21. Referring to FIG. 2, the guitar comprises a body 21; head 23; and a neck 22 connecting the body 21 to the head 23, and various operation means such as a bridge 211, a pickup 213, a pickup switch, a regulating nob or a saddle may be coupled to the body 21. The electric guitar may become various kinds of guitars such as an active guitar or a passive guitar. And also, various means for operating the electric guitar may be placed at the guitar, and a connecting jack for being connected to the amplifier may be formed at the body. And an electric vibration made by the pickup 213 may be transmitted to the amplifier through the wire line connected the connecting jack. A placing space may be formed at the body 21, for example, and a cut portion may be formed at a front side of the body 21, and the placing space may be made. And the effector 12 may be secured at the placing space. And also, a cut portion may be formed at a rear side of the body 21, and a receiving box 24 may be made. And a battery may be placed in the battery receiving box 24 to be connected to the effector 12 electrically. The effector 12 may comprise the regulating board 25 and the operating board 26 coupled to the regulating board 25. The regulating board 25 may be exposed to the outside of the body 21, and the operating board 26 may be coupled to a lower part of the regulating board 25 to be placed within the body 21. Specifically, the regulating board 25 with a plate shape may be secured at the front side of the body 21 by a plurality of fixing bolts FB1 to FB4, and an on/off switch or a plurality or regulating buttons disposed at the regulating board 25 may be exposed to the outside of the front side the body 21. And also, the battery B may be received within the battery receiving box 24 formed at the rear side of the body 21. And the effector 12 may be connected to the jack connected to the battery B, the pickup 213 and the amplifier. The effector 12 having such structure is discussed below in more detail.

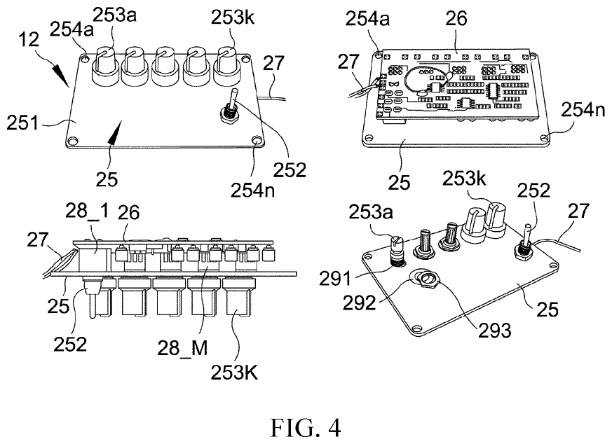

FIG. 4 shows an embodiment of an effector coupled to a guitar according to the present invention.

Referring to FIG. 4, an operating switch 252 and at least one regulating button 253a to 253k may be placed at the effector 12, and the effector 12 comprises the regulating board 25 where fixing holes 254a to 254n are formed; and the operating board 26 where an electronic element for generating various sound effects is placed. The regulating board 25 and the operating board 26 may comprise a regulating body 251 and an operating body with a plate shape, respectively. The regulating body 251 and the operating body may be coupled in a layered structure each other. For example, the operating body is coupled to the regulating body 251, and a plurality of fixing means may be screwed in at the fixing holes 254a to 254n formed at a circumferential portion of the regulating body 251 to secure the regulating body 251 at the front side of the guitar body. Thus, one side of the regulating body 251 may be exposed to the outside of the guitar body to seal the cut portion of the guitar body. And the operating switch 252 and the regulating buttons 253a to 253b may be exposed to the outside to operate the effector 12. The operating body may be coupled to the regulating body 251 by a coupling blocks 28_1 to 28_M, and the coupling block 28_1 to 28_M may connect the operating switch 252 and the regulating button 253a to 253k to an electronic element or an electronic part placed at the operating board 26. Specifically, one side of the coupling blocks 28_1 to 28_M may be secured at the operating body to connect the operating switch 252 and the regulating buttons 253a to 253k to the related electronic elements. And a connector 291 may be formed at a surface where the coupling blocks 28_1 to 28_M contacts the regulating body 251, and the connector 291 may penetrate the regulating body 251 from a rear surface to a front surface. And a buffering means 292 and a fixing means 293 may be coupled to the connector 291 to secure the coupling blocks 28_1 to 28_M at the regulating body 251, and thus, the operating board 25 may be fixed at the regulating board 26. The connector 291 may be a hollow tube shape, and the switch 252 or the regulating button 253a to 253k may be coupled to the connector 291 for being connected to an operating circuit or a regulating circuit placed within the coupling blocks 28_1 to 28_M electrically at a condition of coupling the connector 291 to the regulating body 251. An operating wiring 27 including a plurality of wires may be connected to the operating board 26, and the operating wiring 27 may connect the battery, the pickup or the amplifier to the operating board 26 electrically. The effector 12 may have various board structures, but not limited to. The present invention may be utilized for various guitar manufacturing industry, an electric guitar manufacturing industry or an electronic device industry.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A guitar with an effector in an integral form, comprising;
a body forming a portion of the guitar; and
an effector installed within the body,
wherein the effector is connected to the guitar electrically in advance, and the effector starts an operation when the guitar is connected to an amplifier electrically.

2. The guitar according to claim 1, wherein the effector comprises a regulating board integrated with a body of the guitar; and an operating board integrated with the regulating guitar and located within the body.

3. The guitar according to claim 1, wherein the guitar comprises a battery receiving box formed at a rear surface of the body.
